(19) United States
(12) Patent Application Publication
(10) Pub. No.: US 2020/0299416 A1
(43) Pub. Date: Sep. 24, 2020

(54) REGENERATED CELLULOSIC FIBRES SPUN FROM AN AQUEOUS ALKALINE SPINDOPE

(71) Applicant: TREETOTEXTILE AB, BJÄRRED (SE)

(72) Inventor: Lars STIGSSON, BJÄRRED (SE)

(21) Appl. No.: 16/492,612

(22) PCT Filed: Mar. 15, 2018
(86) PCT No.: PCT/SE2018/050256

§ 371 Date: Sep. 10, 2019

Related U.S. Application Data
(60) Provisional application No. 62/471,727, filed on Mar. 15, 2017.

(51) Int. Cl. C08B 16/00; C08B 15/10; D01F 2/24; D01F 2/02

(52) U.S. Cl. CPC C08B 16/00; D01F 2/02; D01F 2/24; C08B 15/10

(57) ABSTRACT

The present invention is directed to a cellulosic fibre composition comprising regenerated cellulose and one or more additives, wherein a) the cellulosic fibre composition is produced by injecting an aqueous alkaline spindope solution or suspension comprising dissolved cellulose in a concentration from about 5% to about 12% by weight of spindope and at least one of an additive and a nano-sized structured particulate filler through a nozzle into an alkaline coagulation bath forming cellulosic filaments; and b) stretching or washing cellulosic filaments from a) in one or more stretching and washing baths forming a regenerated cellulosic fibre.

### FIELD OF THE INVENTION

The present invention is directed to regenerated cellulosic fibre, a composition thereof and a method for producing a regenerated cellulosic fibre composition.

### TECHNICAL BACKGROUND

Regenerated cellulosic fibres produced from dissolving pulps using cold alkali processes such as the cold alkali urea process, cold alkali zinkate and the carbamate process produces fibres with rather low wet strength. These processes also build on rather complex cellulose pre-treatment procedures in order to dissolve the cellulose in the alkaline solution.

EP2116557A1 teaches that a cellulose dope can be manufactured from a fibrous cellulosic raw material such as paper making pulp or dissolving grade pulp with DP in the range 500 and 1200 by first subjecting the cellulose fibres to a mechanical treatment in the wet state so that the outer surfaces of the fibres are broken at least partially followed by an enzymatic treatment (endoglucanase type cellulase) that reduces DP by 30 to 60% compared to the initial DP. After the enzymatic pre-treatment, the cellulosic raw material is mixed in an aqueous solution which contains alkali metal hydroxide (e.g. sodium hydroxide) and zinc salt (e.g. zinc oxide) in order to create conditions where the cellulosic raw material can begin to dissolve. It is further taught that for production of regenerated cellulosic fibres, the target cellulose concentration should be at least 5.0%. Regenerated cellulosic fibres are thereafter produced by coagulating the spindope in an acidic bath. Wet strength of the fibre is in the range of 8-10 cN/dtex which is deemed too low for many applications.

U.S. Pat. No. 5,401,447 is focused on acidic coagulation chemistry and temperature as well as steaming as a method of slightly improving wet strength of fibres and films after coagulation.

U.S. Pat. No. 5,605,567 teaches the manufacture of a cellulose dope by subjecting an alkali pulp slurry to cavitations, for instance by means of sonication. A problem associated with the method described for producing a cellulose dope in U.S. Pat. No. 5,605,567 is that only a part of the cellulose is dissolved making the dope unsuitable for fibre spinning unless the DP is very low (e.g. 195). Such a low DP would result in products having poor mechanical properties.

A key objective of the present invention is to provide a cellulosic fibre and methods of providing regenerated cellulosic fibre produced by a cold alkali process said fibre having improved mechanical properties, in particular improved wet strength, relative to prior art regenerated cellulosic fibres produced from spindopes comprising cellulose dissolved in an alkaline solvent.

### SUMMARY OF THE INVENTION

The present invention is directed to high wet strength cellulosic fibres produced by wet spinning an alkaline spindope composition comprising cellulose polymers and at least one nanofiller additive and optionally one or more polymeric additives characterized in that the nanofiller additive consist of at least one of an inorganic clay, polymer particles or cellulose nanocrystals. The present invention is also directed to a composite cellulosic fibre comprising cellulose and at least one nanofiller enhancing the wet strength of the cellulosic fibre. Furthermore the present invention is directed to forming cellulosic fibres in one or more coagulation and fibre forming baths wherein a first coagulation bath is an aqueous liquid with a pH over 7.

These and other features, aspects and advantages of the present invention will become better understood with regard to the following description.

### DESCRIPTION OF THE INVENTION

Regenerated cellulosic fibres herein are defined as cellulosic fibres comprising more than 85% by weight of cellulose. Cellulose is derived from D-glucose units, which condense through β(1→4)-glycosidic bonds. This linkage motif contrasts with that for a (1→4)-glycosidic bonds present in starch, glycogen, and other carbohydrates. Cellulose is a straight chain polymer: unlike starch, no coiling or branching occurs, and the molecule adopts an extended and rather stiff rod-like conformation, aided by the equatorial conformation of the glucose residues. The multiple hydroxyl groups on the glucose from one chain form hydrogen bonds with oxygen atoms on the same or on a neighbour chain. Hydrophobic interactions combined with hydrogen bonds hold the chains firmly together side-by-side and forming microfibrils with high tensile strength. This confers to tensile strength in cell walls, where cellulose microfibrils are meshed into a polysaccharide matrix.

Celluloses are well known and are described, for example, in Encyclopedia of Polymer Science and Technology, 2nd edition, 1987. Celluloses are natural carbohydrate high polymers (polysaccharides) consisting of anhydroglucose units joined by an oxygen linkage to form long molecular chains that are essentially linear. Cellulose can be hydrolyzed to form glucose. The degree of polymerization DP ranges from 1000 for wood pulp to 3500 for cotton fibre, giving a molecular weight of from 160,000 to 560,000. Cellulose can be extracted from several types of vegetable tissues (wood, grass, and cotton).

Several different crystalline structures of cellulose are known, corresponding to the location of hydrogen bonds between and within strands. Natural cellulose is cellulose I, with structures I_{α} and I_{β}. Cellulose produced by bacteria and algae is enriched in I_{α} while cellulose of higher plants consists mainly of I_{β}. Cellulose in regenerated cellulose fibres is composed of cellulose II. The conversion of cellulose I to cellulose II is irreversible, suggesting that cellulose I is metastable and cellulose II is stable. With various chemical treatments it is possible to produce the structures cellulose III and cellulose IV.

Many properties of cellulose depend on its chain length or degree of polymerization DP, the number of glucose units that make up one polymer molecule. Cellulose from wood pulp has typical chain lengths between 300 and 1700 units; cotton and other plant fibres as well as bacterial cellulose have chain lengths ranging from 800 to 10,000 units. Molecules with very small chain length resulting from the breakdown of cellulose are known as cellodextrins; in contrast to long-chain cellulose, cellodextrins are typically soluble in water and organic solvents.

Plant-derived cellulose is usually found in a mixture with hemicellulose, lignin, pectin and other substances, while bacterial cellulose is quite pure, has a much higher water content and higher tensile strength due to higher chain lengths.

Natural cellulose has a very high average molecular weight and a broad molecular weight distribution. The average molecular weight of cellulose can be reduced to the desirable range for the present invention by acid reduction, oxidation reduction, enzymatic reduction, hydrolysis (acid or alkaline catalyzed), physical/mechanical degradation (e.g., via the thermomechanical energy input of the processing equipment), or combinations thereof. Reduction of wood based cellulose DP to the desired range can be performed by modifying the prehydrolysis step, the cooking step or the pulp bleaching step. For example an oxidant alone or together with a metal such as iron or manganese may be introduced into alkaline oxygen delignification stage to promote yield preserving glycosidic bond cleavage. A chloride dioxide stage may be operated at harsher acids conditions. Dissolving quality pulp may be hydrolysed to the desired DP level by treatment with acids such as sulfuric acid, washing the pulp and thereafter dissolving the pulp in the solvent. The exact chemical nature of the cellulose and molecular weight reduction method is not critical as long as the average molecular weight is in an acceptable range.

Cellulose contains a number of hydroxyl groups which are hydrophilic, however cellulose is completely insoluble in water due to strong hydrophobic interactions.

Although not required, substituted cellulose can be used in part or in all the cellulose used for manufacturing the cellulosic spindope of the present invention. If substituted cellulose is used, chemical modifications of cellulose typically include one or more of carbamatisation, etherification and esterification. Substituted cellulose may be desired for better compatibility or miscibility with the nanofiller additive. The degree of substitution of the chemically substituted cellulose is from about 0.01 to 1. A low degree of substitution, 0.01 to 0.3, is preferred.

From the viewpoint of reducing the cost for producing the cellulosic fibre of the present invention it is preferred that the cellulose content of the cellulose dope is above about 5% by weight of the spindope, while keeping the dissolution ratio of the cellulose in the alkaline cellulose dope at 99.0% by weight or more. For attaining this objective, it is, as alluded to hereinabove very effective to partially modify the hydroxyl groups of the cellulose in the cellulose slurry by reaction with a reagent which is reactive with a hydroxyl group in the presence of an alkali (derivatization). Examples of such reagents include carbamate, a vinyl compound and an etherification agent. When such a reagent is not used, the cellulose content of the cellulose dope of the present invention is usually in the range of from 5 to 7% by weight. On the other hand, by employing the above-mentioned modification of the hydroxyl groups of the cellulose, the cellulose content of the cellulose dope can usually be increased to the range of from 7 to 12% by weight. Addition of the derivatisation reagent can be conducted in any appropriate stage in the process for producing the cellulose dope of the present invention.

Typically, the spindope composition of the present comprises from about 5 to about 12%, preferably from about 5 to about 9% of cellulose or derivatised cellulose.

### Viscosity Average Degree of Polymerization Definition (DP)

The viscosity average degree of polymerization of cellulose is defined by the following standard procedure. The viscosity [ηn] value of a cellulose/Cadoxen solution is obtained, and the obtained [η] value is substituted for the [η] in the below-mentioned viscosity formula of Brown and Wikstrom (described in Euro. Polym. J, 1, 1 (1966)) to obtain a viscosity average molecular weight (Mw). The obtained viscosity average molecular weight (Mw) is divided by 162, and the value obtained by the division is defined as the viscosity average degree of polymerization (DP). The method for preparing Cadoxen is also described in the above-mentioned Euro. Polym. J, 1, 1 (1966).

[η]=3.85×10−2×MW0.76

### Spindope Preparation

It is well known in the art of preparing regenerated cellulosic fibres by dissolving cellulose in an aqueous cold alkali solution and forming new fibres by coagulating the spindope in an acidic solution such as sulphuric acid that the resulting fibres have a rather low wet strength, often in the range of 8-12 cN/dtex or even lower.

At a cellulose content of less than about 4% by weight in the spindope, the cellulose contained in the cellulose dope is easily solubilised yielding a stable spindope with low tendency to gelation. Higher cellulose content in the spindope, however is desirable from both technical and economic reasons and it is an object of the present invention to have a higher cellulose content in the range of 5-12% by weight of the spindope. The sodium hydroxide solvent used should be cold, preferably below about −2 C when mixing cellulose and solvent in a spindope preparation step.

As briefly alluded to above it is not possible to produce a homogeneous alkaline cellulose spindope having a high content of underivatised cellulose higher than about 5% by weight without depolymerisation of the cellulose to DP levels below about 300. It is recognized that the higher the cellulose content and the polymerization degree of the cellulose, the more unstable and susceptible to gelation the cellulose spindope becomes. The viscosity average degree of polymerization (DP) of cellulose in the cellulose slurry varies depending on various factors, such as the desired properties of a cellulose shaped article to be produced, and the desired degree of the stability of the cellulose dope during the course of the production. It is preferred that the viscosity average degree of polymerization (DP) in the present invention is from 200 to 700, more advantageously from 200 to 500 (corresponding to cellulose chains with molecular weight Mw in the range of 32 400 to 81 000). While it is easier to dissolve cellulose in sodium hydroxide solvent the lower the (DP) and more cellulose can be dissolved, the mechanical strength of a cellulose shaped article produced becomes lower when the viscosity average degree of polymerization (DP) is less than about 350.

A key objective of the present invention is therefore to provide a depolymerised cellulose permitting good dissolution in alkali at levels about 5% by weight of spindope and still get good mechanical properties of the resulting regenerated cellulosic fibre. This is achieved by the addition of one or more nanofiller additives to the spindope and preferably by gel coagulation of the spindope in a coagulation bath having a pH above about 7.

A cellulose dope for use in manufacturing the regenerated cellulosic fibre of the present invention can be produced by providing a cellulose slurry comprising a cold aqueous sodium hydroxide solution and finely dispersed therein a nanofiller additive and cellulose, the spindope having a sodium hydroxide concentration of from about 6% to about 9% by weight and a cellulose content of 5% by weight or more and a nanofiller additive content of from about 0.1% to 10% by weight calculated on the cellulose. The spindope may be manufactured by any well known procedure in the art of dissolving cellulose into cold alkali.

Examples of celluloses used for preparing the cellulose slurry include natural cellulose, such as pulp, cotton and cotton linter; and regenerated cellulose obtained from a cellulose solution, such as viscose or a lyocell. The cellulose may be derivatised. These celluloses can be used individually or in combination.

A homogeneous composition is required for fibre spinning. For spinning very fine fibres, small defects, slight inconsistencies, or non-homogeneity in the spinning dope are not acceptable for a commercially viable process. The more attenuated the fibres, the more critical the processing conditions and selection of materials.

Fibre attenuation or fibre fineness is often measured as dTex. Tex is a unit of measure for the linear mass density of fibres, yarns and thread and is defined as the mass in grams per 1000 meters. The unit code is “tex”. The most commonly used unit is actually the decitex (abbreviated dTex), which is the mass in grams per 10,000 meters. When measuring objects that consist of multiple fibres, the term “filament tex” is sometimes used, referring to the mass in grams per 1000 meters of a single filament.

The fineness of the regenerated cellulosic fibre of the present invention is in the range of 1-2 dTex, preferably in the range of 1.1-1.5 dTex.

### Gelation Coagulation and Fibre Stretching/Washing

Cellulose can be dissolved in an aqueous sodium hydroxide solution only at a specific sodium hydroxide concentration range i.e., a sodium hydroxide concentration of from 6.5 to 11% by weight. In other words, when a solution obtained by dissolving cellulose in an aqueous sodium hydroxide solution (i.e., a cellulose dope) is contacted with a liquid other than an aqueous sodium hydroxide solution having a sodium hydroxide concentration of from 6.5 to 11% by weight, gelation occurs. Therefore, a liquid other than an aqueous sodium hydroxide solution having a sodium hydroxide concentration of from 6.5 to 11% by weight can potentially be used as a gelling or coagulation agent for the above-mentioned cellulose dope.

It is known that with respect to the liquid used as a gelling agent, water and aqueous solutions can be used. When an aqueous solution of a salt is used as a gelling agent, the higher the concentration of the salt in the solution and the lower the gelation temperature and the higher the structural density and mechanical strength of the obtained regenerated cellulosic fibre. On the other hand, a cellulosic fibre obtained by subjecting a dope to gelation coagulation using hot water only as a gelling agent exhibits a very low structural density and low mechanical strength. The preferred coagulation liquid of the present invention is diluted sodium hydroxide (concentration of sodium hydroxide substantially below the sodium hydroxide concentration in the spindope) preferably kept at a temperature of about 10-40 C said coagulation liquid optionally containing a dissolved salt, an aluminium compound, a magnesium compound and/or sodium carbonate or sodium sulphate. The coagulation bath may also consist of an organic alcohol or ketone alone or combined with salts.

It is a core objective of the present invention to provide a regenerated cellulosic fibre with a high mechanical strength, in particular high strength in the wet state. This is achieved by the proper blending and homogeneously dispersing of a nanofiller additive into the spindope forming a percolation network and a fine structure involving hydrophobic interaction forces and a strong hydrogen bonded structure in the resulting fibre generated during gelation coagulation, washing and stretching the nascent fibres, fibres and filaments in stretching and washing baths.

The gelation coagulation step of present invention is preferably performed in an aqueous alkaline solution at a pH level above 7.

Following the gelation coagulation step the nascent filaments or filament tow may be stretched and washed in one or more stretching baths. In one embodiment stretching and washing is performed in alkaline baths. In one embodiment at least one stretching or washing bath is acidic.

In one embodiment of the present invention derivatised cellulose is underivatised in an alkaline coagulation, stretching or washing bath, including underivatisation of cellulose carbamate lowering the nitrogen content of the resulting regenerated cellulosic fibre.

In another embodiment the cellulose spindope besides cellulose and nanofiller additive also comprises a polymer additive interacting with the nanofiller cellulose structure. In one embodiment the polymer additive present in the nascent fibre of filament tow is chemically changed in an acidic washing or stretching bath, for example by desalting a sodium salt of a polymeric additive, forming new strong hydrogen bonds between polymer and cellulose.

Dried cellulose fibres manufactured in accordance with the invention may be subjected to heat treatment to increase the cellulose crystallinity. For the heat treatment, a sample of cellulose fibre mat may be placed in a 50% (v/v) aqueous ethanol solution and heated at 65° C. for one hour, after which the sample may be washed with ethanol and dried.

After optional other fibre treatment steps such as bleaching, drying, cutting the regenerated cellulosic fibre product with a high wet tensile strength is obtained as a staple fibre or filament yarn.

### Polymeric Additives

Additive polymers which are at least partially soluble in alkali and substantially compatible with cellulose can advantageously be used in the present invention in order to support the wet tensile strength properties of the regenerated cellulosic fibres. As used herein, the term “substantially compatible” means that the polymer is capable of forming a substantially homogeneous mixture with the cellulose after mixing with shear or extension.

The polymer additive must have molecular and rheological characteristics suitable for blending with cellulose in an alkaline spindope. The molecular weight of the polymer additive must be sufficiently high to enable entanglement between polymer molecules and yet low enough to be wet spinnable. For appropriate blending and wet spinning the cellulose polymeric additive blend polymers having molecular weights (Mw) below about 1,000,000 g/mol, preferably from about 5,000 g/mol to about 700,000 g/mol, more preferable from about 75,000 g/mol to about 600,000 g/mol and most preferably from about 100,000 g/mol to about 500,000 g/mol should be used.

The polymer additive must be able to solidify fairly rapidly in the coagulation bath or stretching and washing baths, preferably under extensional flow, and form a stable fibre structure with the cellulose, as typically encountered in known processes as a staple fibre (wet spin draw process) continuous filament process.

Suitable polymer additive s includes polymers and polymer adducts at least partially soluble in alkali including alkali soluble polymeric adducts of polypropylene base and copolymers of polypropylene, polyethylene base and copolymers of polyethylene, polyamides and copolymers of polyamides, polyesters and copolymers of polyesters, and mixtures thereof. Other suitable polymers include polyimides, polyvinyl acetates, polyethylene/vinyl acetate copolymers, polyethylene/methacrylic acid copolymers, polystyrene/methyl methacrylate copolymers, polymethyl methacrylates, polyethylene terephalates and combinations thereof. Other nonlimiting examples of polymers include adducts of polybutylene, polycarbonates, poly(oxymethylene), styrene copolymers, polyetherimide, poly(vinyl acetate), poly(methacrylate), poly sulfone, polyolefin carboxylic acid copolymers such as ethylene acrylic acid copolymer, ethylene maleic acid copolymer, ethylene methacrylic acid copolymer, ethylene acrylic acid copolymer, and combinations thereof, homogeneously-branched, linear ethylene/α-olefin copolymers. Preferred polymers include acid substituted vinyl polymers such as ethylene acrylic acid which is commercially available as PRIMACOR by Dow and polyacrylamid-co acrylic acid, hydroxy-functionalized polyethers or polyesters, polyolefin carboxylic acid copolymers, and combinations thereof.

Another preferred polymer additive, or rather block co-polymer additive, is spider silk protein adducts including but not limited to proteins wherein the primary structure is an amino acid sequence mainly consisting of highly repetitive glycine and alanine blocks.

Depending upon the specific polymer used, the process, and the final use of the fibre, use of more than one polymer additive in the spindope may be desired.

The polymer additive or additives of the present invention is present in an amount to improve the mechanical properties of the fibre product and improve attenuation of the fibre. Typically, calculated as percentage of cellulose in the spindope the polymers are present in an amount of from about 0.1% to about 10%, preferably from about 1% to about 8%, more preferably from about 2% to about 5%, and most preferably from about 3% to about 5%, by weight of the fibre, the remainder being cellulose or derivatised cellulose and optionally minor quantities of other additives such as urea, zinc and other ingredients as discussed below.

Optionally, other ingredients may be incorporated into the spinnable cellulose composition. These optional ingredients may be present in quantities of less than about 10%, preferably from about 0.1% to about 10%, and more preferably from about 0.1% to about 8% calculated as percentage of the cellulose in the spindope composition. The optional materials may be used to modify the processability and/or to modify physical properties such as elasticity, tensile strength and modulus of the final product. Other benefits may include, but are not limited to, stability including oxidative stability, brightness, color, flexibility, resiliency, workability, processing aids, viscosity modifiers, and odor control. Nonlimiting examples include salts, slip agents, crystallization accelerators or retarders, odor masking agents, cross-linking agents, emulsifiers, surfactants, cyclodextrins, lubricants, other processing aids, optical brighteners, antioxidants, flame retardants, dyes, pigments, fillers, proteins and their alkali salts, waxes, tackifying resins, extenders, and mixtures thereof. Slip agents may be used to help reduce the tackiness or coefficient of friction in the fibre. Also, slip agents may be used to improve fibre stability, particularly in high humidity or temperatures.

Other additives are typically included with the cellulose and polymeric additive such as a processing aid and to modify physical properties such as elasticity and dry tensile strength of the wet spun cellulosic fibres. Suitable extenders for use herein include gelatin, vegetable proteins such as sunflower protein, soybean proteins, cotton seed proteins, and water soluble polysaccharides; such as alginates, carrageenans, guar gum, agar, gum arabic and related gums, pectin, water soluble derivatives of cellulose, such as alkylcelluloses, hydroxyalkylcelluloses, and carboxymethylcellulose. Also, water soluble synthetic polymers, such as polyacrylic acids, polyacrylic acid esters, polyvinylacetates, polyvinylalcohols, and polyvinylpyrrolidone, may be used.

Other additives may be desirable depending upon the particular end use of the fibre product contemplated. For example, in certain textile products very high wet strength is a desirable attribute. Thus, it is often desirable to add to the spindope cross-linking agents known in the art as “wet strength” resins. A general dissertation on the types of wet strength resins utilized in the paper art can be found in TAPPI monograph series No. 29, Wet Strength in Paper and Paperboard, Technical Association of the Pulp and Paper Industry (New York, 1965). The most useful wet strength resins have generally been cationic in character. Polyamide-epichlorohydrin resins are cationic polyamide amine-epichlorohydrin wet strength resins which have been found to be of particular utility. Glyoxylated polyacrylamide resins have also been found to be of utility as wet strength resins. Polyethylenimine type resins, glutaraldhyde and glyoxal may also find utility as crosslinkers in the present invention.

For the present invention, a suitable cross-linking agent is added to the composition in quantities ranging from about 0.1% by weight to about 10% by weight, more preferably from about 0.1% by weight to about 3% by weight of the cellulose in the spindope.

The cellulose and polymers in the fibres of the present invention may be chemically associated. The chemical association may be a natural consequence of the polymer chemistry or may be engineered by selection of particular materials. This is most likely to occur if a cross-linking agent is present. The chemical association may be observed by changes in molecular weight, NMR signals, or other methods known in the art. Advantages of chemical association include improved water sensitivity, reduced tackiness, and improved mechanical properties, among others.

Spunbond structures, staple fibres, hollow fibres, shaped fibres, such as multi-lobal fibres and multicomponent fibres can all be produced by using the compositions and methods of the present invention. Multicomponent fibres, commonly a bicomponent fibre, may be in a side-by-side, sheath-core, segmented pie, ribbon, or islands-in-the-sea configuration. The sheath may be continuous or non-continuous around the core. The ratio of the weight of the sheath to the core is from about 5:95 to about 95:5. The fibres of the present invention may have different geometries that include round, elliptical, star shaped, rectangular, and other various eccentricities. The fibres of the present invention may also be splittable fibres. Splitting may occur by rheological differences in the polymers or splitting may occur through mechanical means and/or by fluid induced distortion.

The fibres described herein are typically used to make textile and home textile articles. The cellulosic fibre articles produced from the fibres will exhibit certain mechanical properties, particularly, strength, flexibility, softness, and absorbency. Measures of strength include dry and/or wet tensile strength. Flexibility is related to stiffness and can attribute to softness. Softness is generally described as a physiologically perceived attribute which is related to both flexibility and texture. Absorbency relates to the products' ability to take up fluids as well as the capacity to retain them.

The wet tensile strength of a cold alkali cellulosic fibre produced without nanofillers and/or polymeric additive addition in accordance with the present invention is limited to approximately 8-10 cN/dtex. Therefore a key function of the nanofiller and/or polymeric additive addition in accordance with the invention is to increase wet strength of the resulting regenerated cellulosic fibre. The fibres of the present invention have a tensile strength of greater than about 10 cN/dtex, preferably greater than about 12 cN/dtex and more preferably greater than about 15 cN/dtex. Wet tensile strength is measured using standard procedure for textile fibre strength in wet condition.

### Inorganic Nano Particular Fillers

The wet tensile strength of cellulosic fibres can be significantly enhanced by the addition of certain nano sized particles to the spindope forming a composite cellulosic fibre upon coagulation of the spindope. Halloysite or carbon nanotubes are examples of inorganic nanofillers that can be added to the alkaline spindope in the present invention.

### Processes

The first step in producing a fibre from dissolving cellulose pulp or cotton linter pulp having the appropriate composition and DP is the mixing step wherein polymer additive and cold alkali (+5 to −15 C) are mixed with the cellulose pulp. In the mixing step the raw materials are blended and very thoroughly mixed, typically under shear. The shearing and mixing preferably performed under subzero temperature will result in a homogeneous spindope ready for filtration, deaeration, injection into spinerettes and fibre forming.

The fibres of the present invention may be bonded or combined with other synthetic or natural fibres to make textile articles. The synthetic or natural fibres may be blended together in the fibre forming process or used in discrete layers. Suitable synthetic fibres include fibres made from polypropylene, polyethylene, polyester, polyacrylates, and copolymers thereof and mixtures thereof. Natural fibres include cellulosic fibres and derivatives thereof. Suitable cellulosic fibres include those derived from any tree or vegetation, including hardwood fibres, softwood fibres, hemp, and cotton. Also included are fibres made from processed natural cellulosic resources such as rayon or lyocell.

### SUMMARY AND FURTHER BODY FOR CLAIMS

Cellulosic fibre compositions are provided according to aspects of the present invention which fibres are manufactured by providing a spinning dope comprising a solution of cellulose and a polymeric additive and/or a nanostructured additive in an alkaline solvent in which solvent cellulose is present at a concentration from about 5 to 12% by weight and a polymer and/or nanostructured additive is present in the range from 0.1-10% by weight calculated on the cellulose, contacting the cellulose spinning dope with an aqueous coagulation bath fluid preferably having a pH value above 7, forming a regenerated cellulosic fibre composition wherein the fibres have a wet tensile strength of greater than about 10 cN/dtex, preferably greater than about 12 cN/dtex and more preferably greater than about 15 cN/dtex.

Methods for making a regenerated cellulosic fibre composition are provided according to aspects of the present invention which include providing a spinning dope comprising a solution of cellulose and a polymeric additive in an alkaline solvent in which solvent cellulose is present at a concentration from about 5 to 12% by weight and the polymer additive is present in the range from 0.1-10% calculated on the cellulose, contacting the cellulose spinning dope with an aqueous coagulation bath fluid have a pH value above 7, forming a regenerated cellulosic fibre composition; stretching and washing the fibre composition in one or more washing and stretching baths wherein at least one bath is acidic;

Methods for making a regenerated cellulosic fibre composition are provided according to aspects of the present invention which include providing a spinning dope comprising a solution of cellulose and a polymeric additive in an alkaline solvent in which solvent cellulose is present at a concentration from about 5 to 12% by weight and the polymer additive is present in the range from 0.1-10% calculated on the cellulose, contacting the cellulose spinning dope with an aqueous coagulation bath fluid have a pH value above 7, forming a regenerated cellulosic fibre composition; stretching and washing the fibre in one or more washing and stretching baths wherein a carbamate polymer additive is un-derivatised by removing nitrogen groups from the cellulose polymer body into the washing or stretching bath

Methods for making a regenerated cellulosic fibre composition are provided according to aspects of the present invention which include providing a spinning dope comprising a solution of cellulose and a polymeric additive in an alkaline solvent in which solvent cellulose is present at a concentration from about 5 to 12% by weight and the polymer additive is present in the range from 0.1-10% calculated on the cellulose, contacting the cellulose spinning dope with an aqueous coagulation bath fluid have a pH value above 7, forming a regenerated cellulosic fibre composition; stretching and washing the fibre in one or more washing and stretching baths wherein at least one bath is acidic; removing sodium salt groups from polymer additives in at least one washing stretching baths

Methods for making a regenerated cellulosic fibre composition are provided according to aspects of the present invention which include providing a spinning dope comprising a solution of cellulose and a polymeric additive in an alkaline solvent in which solvent cellulose is present at a concentration from about 5 to 12% by weight and the polymer additive is present in the range from 0.1-10% calculated on the cellulose, contacting the cellulose spinning dope with an aqueous coagulation bath fluid have a pH value above 7, forming a regenerated cellulosic fibre composition; stretching and washing the fibre in one or more washing and stretching baths; and exposing the spindope or cellulose fibre composition in the spindope, coagulation, stretching or washing bath to a cross-linking agent in order to produce a cross-linked regenerated cellulose fibre composition.

Methods for making a regenerated cellulosic fibre composition are provided according to aspects of the present invention which include providing a spinning dope comprising a solution of cellulose and a nanostructured additive in an alkaline solvent in which solvent cellulose is present at a concentration from about 5 to 12% by weight and the nanostructured additive is present in the range from 0.1-10% calculated on the cellulose ,contacting the cellulose spinning dope with an aqueous coagulation bath fluid have a pH value above 7, forming a regenerated cellulosic fibre composition; stretching and washing the nascent cellulosic fibre in one or more washing and stretching baths; wherein the nanostructured additive consists of at least one of cellulose nanocrystals and an inorganic clay and wherein the nanostructured additive is present in a range from 0.1% to 10% calculated on the cellulose.

Cellulose fibre compositions are provided according to aspects of the present invention which include at least 90, 95, 99% by weight cellulose and a nanostructured additive filler, wherein the cellulose is cross-linked.

Cellulose nanocrystals (nanowhiskers) or nanofibers are structures with a high aspect ratio (length to width ratio). Typical widths are in the range from 5-20 nanometers and length can vary from 100s to 1000 nanometer up to a length of several micrometers for cellulose nanofibrills.

Due to strong hydrogen bonding interactions between hydroxyl groups present on the surface of cellulose nanostructures nanocrystals and nanofibers of cellulose will form a three-dimensional rigid percolation network within the matrix driven by self-association. This network will enhance the strength properties of the resulting product fibre. The formation of a well dispersed spindope solution comprising the nanostructured filler are not always straightforward and strong particle interactions can cause aggregation of the nanostructures eventually leading to decreased mechanical strength properties of the fibre. Another aspect to consider is that cellulosic nano particulates may be soluble or at least lose its aspect ratio in the alkaline solvent used in the present invention. Therefore in order to facilitate its fine dispersion in the spindope and compatibility with the cellulosic polymers, nascent and developed cellulosic fibre, the surface of the nanostructures/nanofillers used in the practise of the present invention can be modified for example by adsorption of surfactants or coupling agents, etherification, acetylation oxidiation, silylation, amidation or polymer grafting.

The cellulose nanostructures or other nanostructures are preferably dissolved in the cellulose solvent in the desired proportion prior to adding the cellulose solvent to cellulose in a spindope preparation step. The nanostructures may also be added to the cellulose prior to spindope preparation and added in any other fashion known to the artisans skilled in the art of composite manufacturing such as solvent casting, sonication mixing, solvent intercalation.

An all cellulose composite fibre can also be produced by a two-step method involving dissolving a portion cellulose in the solvent which is then regenerated in the presence of undissolved cellulose. Another route for preparing an all cellulose composite fibre involves partial dissolution of the surface of cellulosic fibres then regenerated in situ to form a matrix around the undissolved portion. In both these processing routes the dissolution step is followed by solvent removal and cellulose regeneration using an alkaline solvent optional comprising dissolved salts to increase the coagulation rate.

Other nanostructured particles that can be used as nanofiller in producing the cellulosic fibre composite of the present invention are inorganic particles comprising silica, aluminium, titanium, magnesium or calcium compounds.

Clay mineral particles having a geometry in the form of tubes, nanotubes are particularly useful. Halloysite nanotubes (HNT) is clay material of the kaolin group of clay minerals with the chemical composition of Al2Si2O5(OH)4.nH2O where n=0 and 2 for dehydrated halloysite and hydrated halloysite respectively. HNTs have siloxane surface, tubular geometry and a high stiffness. The HNTs have a rather low density of hydroxyl functional groups interacting well with the hydroxyl groups on cellulose and HNT does not require exfoliation like most other nanoclays. Without being bound to any particular theory it is believed that the significant enhancement of mechanical properties such as wet tensile strength and elongation at break properties in the fibre achieved by the addition of HNT nanofillers to the spindope is attributed to the high aspect ratio of the HNT and strong interaction between hydroxyl groups of HNT and cellulose matrix in the fibre. Typical aspect ratios of HNT, clay particles, nanotubes or other inorganic nanofillers are in the order of 10-300. A halloysite clay nanotube typically have an outside diameter of 30-100 nm and a length of 0.1-3 micrometer.

Cellulose itself is hydrophilic and water resistance is another important physical property of a cellulosic fibre also impacting the wet tensile strength and washability properties of a textile product. Incorporation of HNT and certain other nanoclays with low hydroxyl group density lowers the water absorption of the fibre.

Other nanoclays applicable for use as nanofillers in the present invention is montmorillonite, bentonite, titaniumdioxide.

In a preferred embodiment of the present invention the nanostructured additive used for manufacturing the cellulose composite fibre is a halloysite clay optionally surface modified blended into the spindope alone or combined with cellulose nanocrystals.

According to aspects of the present invention, a spinning dope includes 0.01 to 10 wt nanostructured fillers by weight of the cellulose. According to aspects of the present invention, the fillers includes nanoparticles, such as but not limited nanoparticulate cellulose and/or carbon nanoparticles such as but not limited to carbon nanotubes and graphene. Graphene is an allotrope of carbon in the form of a two-dimensional hexagonal lattice. Exfoliated graphite oxide is directly reduced and deoxygenated into graphene under the strongly alkaline conditions in the spindope and a stable cellulose spindope comprising graphene nanofiller can be prepared in the absence of reducing agents.

Cellulose cross-linkers include but are not limited to polyamide-epichlorohydrin resin, glyoxylated polyacrylamide resin, urea formaldehyde, melamine formaldehyde, polyethylenimine type resin, glyoxal, glutaraldehyde and genipin.

A regenerated cellulosic fibre product for textile application is described wherein the fibre is produced by coagulating an alkaline spindope comprising cellulose in an alkaline coagulation bath said cellulosic fibre having a wet tensile strength over about 12 cN/dtex and said cellulosic fibre comprising over 80% cellulose and at least one of a polymeric additive and a nanostructured filler additive.

A regenerated cellulosic fibre having a wet tensile strength over about 12 cN/dtex is described said cellulosic fibre comprising over 80% cellulose and at least one polymeric additive having a protein structure.

Naturally-occurring fibres or particulate fillers which can be employed for blending in the practice of the present invention are, for example, wood flour, wood pulp, wood fibres, cotton, flax, hemp, or ramie fibres, rice or wheat straw, chitin, chitosan, cellulose materials derived from agricultural products, nut shell flour, corn cob flour, and mixtures thereof.

Cotton linter cellulose may advantageously be blended into the spindope as cellulose diluent provided the average degree of polymerisation Dp of the cotton linter is higher than about 300.

In general, the fibres of the present invention are preferably formed by gel spinning. The fibres of the present invention may be spun into any size, or length desired.

The fibres of the present invention can be blended with other synthetic or natural fibres, such as carbon fibres, cotton, wool, polyester, polyolefin, nylon, rayon, glass fibres, fibres of silica, silica alumina, potassium titanate, silicone carbide, silicone nitride, boron nitride, boron, acrylic fibres, tetrafluoroethylene fibres, polyamide fibres, vinyl fibres, protein fibres, ceramic fibres, such as aluminum silicate, and oxide fibres, such as boron oxide.

1. A cellulosic fibre composition comprising regenerated cellulose and one or more additives, characterized in that
a) the cellulosic fibre composition is produced by injecting an aqueous alkaline spindope solution or suspension comprising dissolved cellulose in a concentration from about 5% to about 12% by weight of spindope and at least one of an additive and a nano-sized structured particulate filler through a nozzle into an alkaline coagulation bath forming cellulosic filaments; and
b) stretching or washing cellulosic filaments from a) in one or more stretching and washing baths forming a regenerated cellulosic fibre.

2. The cellulosic fibre composition according to claim 1, wherein the regenerated cellulosic fibre has a wet tensile strength of greater than about 10 cN/dtex, preferably greater than about 12 cN/dtex and more preferably greater than about 15 cN/dtex.

3. The cellulosic fibre composition according to claim 1, wherein the fibre is manufactured by providing a spinning dope comprising a solution of cellulose and at least one of an additive and a nanostructured particulate filler in an alkaline solvent in which solvent cellulose is present at a concentration from about 5 to 12% by weight and an additive and/or nanofiller in total is present in the range from 0.1-10% by weight calculated on the cellulose, and having been in contacted with the cellulose spinning dope with an aqueous coagulation bath fluid preferably having a pH value above 7.

4. The cellulosic fibre composition according to claim 1, wherein the cellulosic fibre composition is produced in step a) by injecting an aqueous alkaline spindope solution or suspension comprising dissolved cellulose in a concentration from about 5% to about 12% by weight of spindope and at least one nanostructured particulate filler.

5. The cellulosic fibre composition according to claim 1, wherein at least one of said one or more washing and stretching baths is acidic.

6. The cellulosic fibre composition according to claim 1, wherein the additive comprises a nanostructured particulate filler which is well dispersed into and present in the alkaline spindope in a range from 0.1% to 10% by weight calculated on the cellulose, preferably wherein the nanostructured particulate filler is substantially insoluble in alkaline 2-10% by weight sodium hydroxide solutions and has an aspect ratio corresponding to a length between 10 and 3000 nm and a diameter from 3 and 100 nm in diameter, more preferably wherein the nanostructured particulate filler is substantially insoluble in alkaline 2-10% by weight solutions and has been surface modified by chemical reaction or adsorption in order to increase its surface hydrophobicity.

7. The cellulosic fibre composition according to claim 5, wherein the nanostructured particulate filler comprises a nanoclay comprising silica, carbon, aluminium, magnesium or titanium compounds, preferably a halloysite with tubular geometry, carbon nanotubes or graphene.

8. The cellulosic fibre composition according to claim 1, wherein said additive is a polymeric additive.

9. A method for making a regenerated cellulosic fibre composition, characterized by providing a spinning dope comprising a solution of cellulose and an additive in an alkaline solvent in which solvent cellulose is present at a concentration of from about 5 to 12% by weight and the additive is present in the range of from 0.1-10% by weight calculated on the cellulose, contacting the cellulose spinning dope with an aqueous coagulation bath fluid having a pH value above 7, forming a regenerated cellulosic fibre composition; and stretching and washing the fibre composition in one or more washing and stretching baths.

10. The method according to claim 9, wherein said additive includes at least one polymeric additive, preferably sodium salt groups from said polymer additive is released into solution in at least one acidic washing or stretching bath.

11. The method according to claim 9, wherein said additive includes at least one nanostructured particulate filler.

12. The method according to claim 9, wherein at least one of said one or more washing and stretching baths is acidic.

13. The method according to claim 9, wherein a carbamate derivatised cellulose is un-derivatised by removing nitrogen groups from the cellulose polymer body into the washing or stretching bath.

14. The method according to claim 9, further comprising exposing the spindope or cellulose fibre composition in the spindope, in the coagulation, and/or in the stretching or washing bath to a cross-linking agent in order to produce a cross-linked regenerated cellulose fibre composition.

15. The method according to claim 9, wherein said additive added to the spindope comprises nanostructured cellulosic crystals (nanowhiskers) in a range from 0.1% to 10% by weight calculated on the cellulose.

16. The method according to claim 9, wherein the additive comprises a nanostructured particulate filler which is well dispersed into and present in the alkaline spindope in a range from 0.1% to 10% by weight calculated on the cellulose.

17. The method according to claim 16, wherein the nanostructured particulate filler is substantially insoluble in alkaline 2-10% by weight sodium hydroxide solutions and have an aspect ratio corresponding to a length between 10 and 3000 nm and a diameter from 3 and 100 nm in diameter.

18. The method according to claim 16, wherein the nanostructured particulate filler is substantially insoluble in alkaline 2-10% by weight solutions and has been surface modified by chemical reaction or adsorption in order to increase its surface hydrophobicity.

19. The method according to claim 16, wherein the nanostructured particulate filler comprises a nanoclay comprising silica, carbon, aluminium, magnesium or titanium compounds, preferably a halloysite with tubular geometry, carbon nanotubes or graphene.

20. The method according to claim 9, wherein the regenerated cellulosic fibre is stretched to a wet tensile strength of greater than about 10 cN/dtex, preferably greater than about 12 cN/dtex and more preferably greater than about 15 cN/dtex.
